(19) United States
(12) Patent Application Publication
(10) Pub. No.: US 2002/0078435 A1
(43) Pub. Date: Jun. 20, 2002

(54) TABLE DRIVEN CONFIGURATOR ON INTERNET

(76) Inventors: PAMELA P. LIU, SARATOGA, CA (US); CALVIN K. LEUNG, SAN JOSE, CA (US); YEN-SON PAUL HUANG, SARATOGA, CA (US)

Correspondence Address: BURNS DOANE SWECKER & MATHIS L L P, POST OFFICE BOX 1404, ALEXANDRIA, VA, 22313-1404, US

(21) Appl. No.: 09/418,896

(22) Filed: Oct. 15, 1999

(51) Int. Cl. G06F 9/44

(52) U.S. Cl. 717/121

(57) ABSTRACT

A table driven configurator for generating modeling rules on a computer system comprising a model engine for generating a set of modeling rules. The model engine provides and displays to an user a table driven rules generation user interface for soliciting a set of user input data corresponding to a set of product specification queries The model engine then generates in response to the received set of user input data a corresponding set of modeling rules comprising a set of logical statements that are then stored into a memory storage unit. A configurator engine is also provided for then retrieving the set of logical statements from the memory storage unit and converting these modeling rules into a set of corresponding configurator commands that are processed through a validation engine and then converted to displayable screen outputs for the user via a screen generation engine.

### FIELD OF INVENTION

Invention relates to configurator engines and more particularly configurator engines for Internet applications.

### BACKGROUND OF INVENTION

Configurator engine formed with language driven contents is now widespread among corporate sales technology. Configurator engine used to construct product rules for those complex hi-tech manufacturers whose products need to be composed based on certain pre-defined rules. For example, to purchase a PC with 450 MHz, a CPU typically requires a memory of 128 MB, while a PC with 300 MHz CPU will typically require a 64-MB memory. Therefore, current art of configurator technology used programming language statements, such as if-then-else statements to predefine these product combination scenarios.

Programming languages used are mainly artificial intelligence languages such as LISP, etc., or other hard-coded if-then-else rules in high level programming languages such as C++, etc. The problem with using these high level programming language driven technology is the associated high learning curves by end-user typically involved in the marketing area, and those who are familiar with their customer product needs, and not necessary software programming. Another limitation of language driven configurator technology is the need to compile user input that are in these high level programming language statements into binary code. Yet another limitation of the prior art configurators that employ artificial intelligence is that artificial languages in particular often lack flexibility and functionality. Many prior art configurators handle constraints internally in an awkward manner. In particular, prior art configurators often include an expert language system or inference engine that must continuously evaluate the state of the product configuration during development.

One example of such known configuration software is the Calico Quote software, manufactured by Calico Technology, San Jose Calif. With such configuration software, a salesperson with a computer assisting a prospective customer, engages via Internet in an information gathering session and receives information about the customer's product needs, such as budget constraints, model preferences, features desired, configuration options, etc. This information is interactively entered into the configuration software, and the software responds by providing indications that certain configurations are not valid. Another similar approach is provided by Trilogy Technology of Texas. Both company's model designer requires end-user understanding of LISP and above two software provides the workbench for designer to program the LISP language and compiling within the workbench.

Some prior art rely on an interpreted configuration runtime engine, the configuration developer environment will need to generate and compile the development into a standalone executable program, which is another form of a runtime engine.

Another limitation is that prior art configurators either require a user to create a user interface with an external visual interface tool (e.g. VISUAL BASIC), or provide a user interface with only limited flexibility. Thus, these prior art systems are typically hard-coded and therefore difficult to maintain and update.

There is therefore a need for improved configurator software that is easier to create and maintain.

### SUMMARY OF INVENTION

A table driven configurator for generating modeling rules on a computer system is provided according to the principles of this invention comprising a model engine for generating a set of modeling rules. The model engine provides and displays to a user a table driven rules generation user interface for soliciting a set of user input data corresponding to a set of product specification queries. The model engine then generates in response to the received set of user input data a corresponding set of modeling rules comprising a set of logical statements that are then stored into a memory storage unit. A configurator engine is also provided for then retrieving the set of logical statements from the memory storage unit and converting these modeling rules into a set of corresponding configurator commands that are processed through a validation engine. Once validated, the set of configurator commands are then executed by the computer and then converted to displayable screen outputs for the user via a screen generation engine.

It is a particular object of the present invention to provide a new modeling rule generation architecture, without using any language or form of interpretation engines to interpret user input data. Since the set of user input data solicited by the model engine are converted to logical statements, such as AND statements, complicated programming language interpreters are thereby avoided.

It is a further object of the present invention to provide a method of producing a new configurator of above-mentioned type that is commercially available, without compilation, and that which can be accessed through the Internet.

In accomplishing the forgoing objects, there is provided in accordance with the present invention a configurator for use in both via Internet and on desktop environment particularly for quotations or other purposes used for describing a desired product with several components using model rules.

In another aspect, the present invention provides a method of producing sales when purchasing a product with rules via the following steps:

From a developers' perspectives:

1. A table driven Internet web page that accepts rules inputs without requiring a complex computer language format.

2. No compilation of the user provided input data is required.

3. One or more configurator commands are generated by a configurator engine in response to retrieving and processing a set of model rules generated by the model engine in response to the set of solicited user data.

4. The table driven model engine is capable of running both over a sever or on the same desktop computer.

From a shoppers' perspectives:

1. A validation command accepts end-users' input of selection and generates an interactive response.

Other objects, features, and advantage of the present invention will become apparent from the detailed description of the preferred embodiments of the invention, which follows when considered in light of the accompanying drawing.

### BRIEF DESCRIPTION OF DRAWINGS

FIG. 1. Illustrates a generalized block diagram of a table driven configurator provided in accordance with the principles of this invention.

FIG. 2. Illustrates a sample table driven rules generation user interface screen for soliciting a set of user input data.

FIG. 3 illustrates a sample screen display driven by a configurator engine as a processing the set of user input data retrieved by the configurator engine and following validation by the validation engine.

FIG. 4. Illustrates a sample model engine process for generating a set of modeling rules;

FIG. 5. Illustrates a sample validation engine process for validating retrieved modeling rules generated from the set of user input.

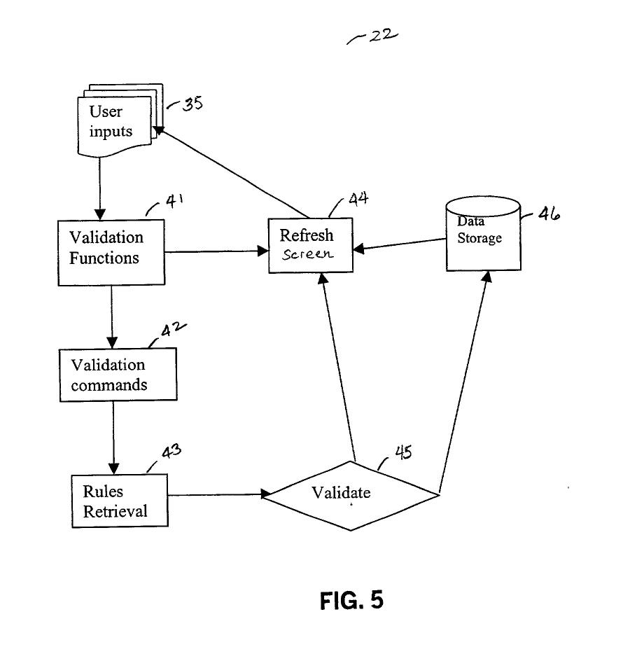

FIG. 6. Illustrates a configuration engine execution process for configuration commands execution.

### DETAILED DESCRIPTION OF PREFERRED EMBODIMENT(S)

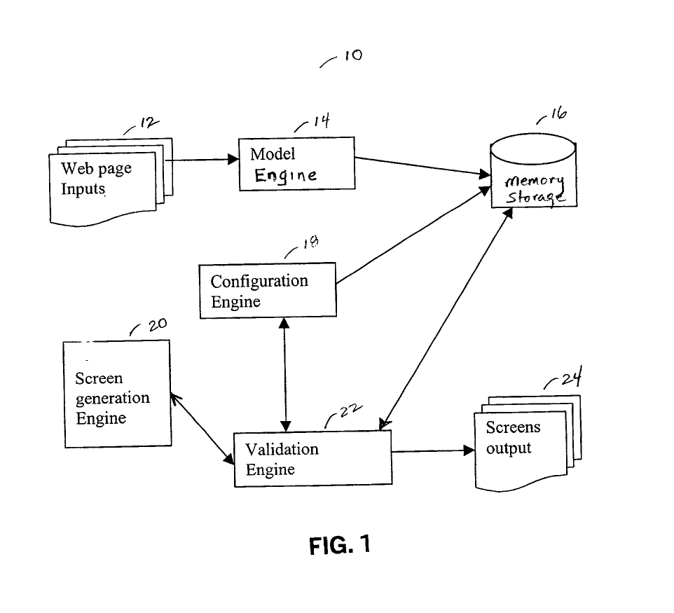

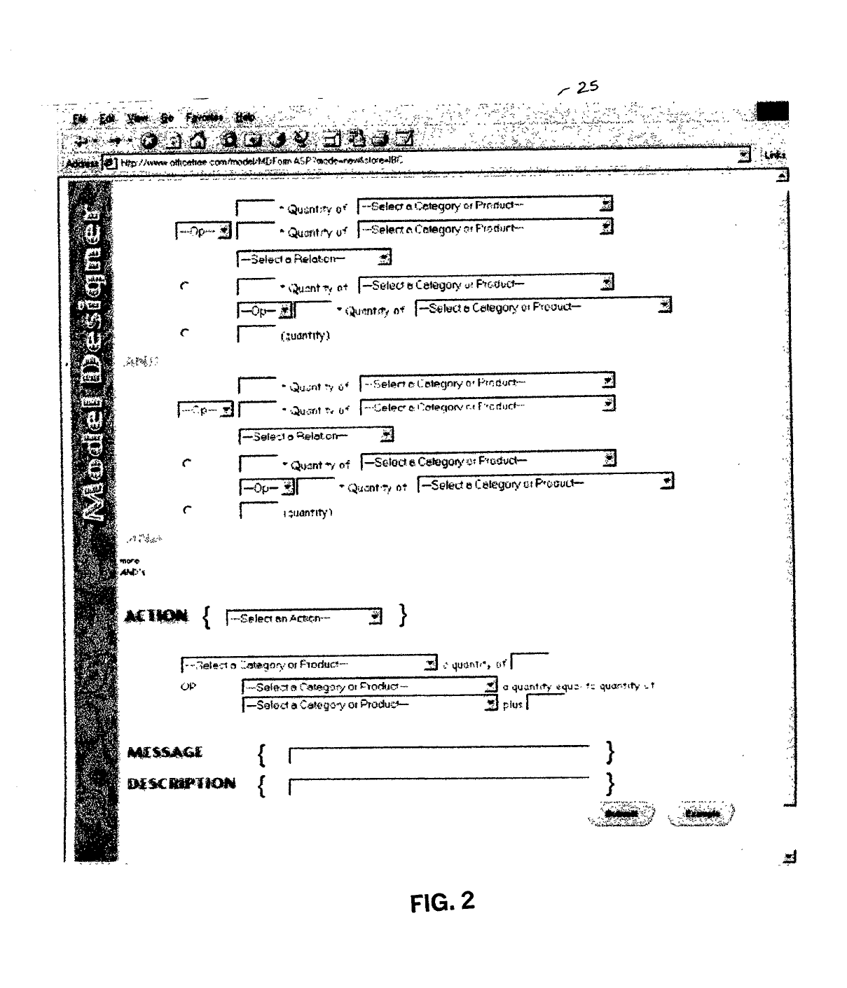

FIG. 1 is a generalized block diagram of a table driven configurator provided in accordance with the principles of this invention. Table driven configurator 10 receives a set of user input data 12, in response to one or more table driven web pages (such as Web page 25 of FIG. 2) provided over an Internet, is received by a model engine 14. Alternatively, it is contemplated that table driven web page 25 could also comprise a table driven user interface that is generated to be displayed locally in a desktop environment, without a server as via an Internet access.

As shown in FIG. 1, a table driven configurator 10 is provided for generating modeling rules on a computer system the table driven configurator comprising a model engine 14 for generating product rules. Model engine 14 comprises a table driven rules generation user interface such as the HTML web page 25 of FIG. 2 for receiving one or more user inputs 12 and generating in response thereto a corresponding set of modeling rules that are stored into a memory storage device 16. A configurator engine 18 coupled to the memory storage unit to receive the stored set of modeling rules drives and process the set of modeling rules to thereby generate a set of screen outputs 24 responsive to the one or more user inputs 12. Configurator engine 18 further comprises a validation engine 22 for checking the retrieved set of modeling rules and validating the set of modeling rules, while a screen generation engine 20 is also coupled to validation engine 222 to generate the set of screen outputs 24 responsive to the one or more user inputs.

### Model Engine

In accordance with the principles of this invention, table driven configurator 10 of FIG. 1 provides a configurator architecture that describes relationship between parts and its sub-components in simplified form via a table driven interface linking the following elements:

1. AND operator

2. Parts relationship with Quantity

3. An Action operator

Because of the simplification of relationship to reducing data relating to user desired parts and sub-components down to expression using only the above described elements via a table driven interface, modeling rules are not necessary, nor need to be compiled. In addition, modeling rules generated by model engine 14 with the above elements and operators facilitate maintenance of the relational elements of product and sub-components information through the Internet.

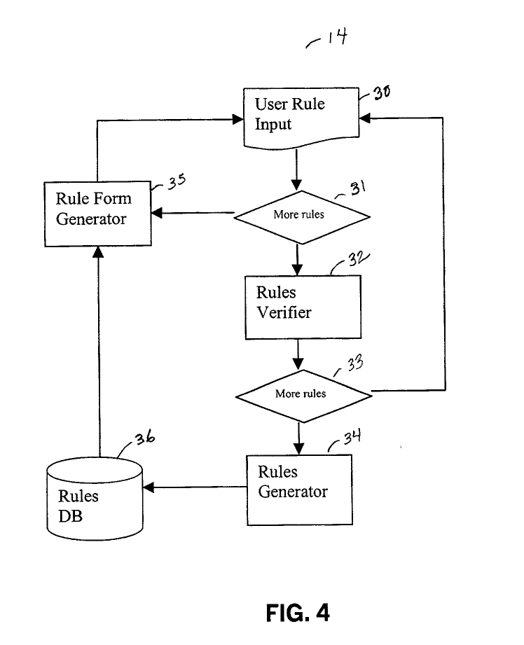

FIG. 4 illustrates a more detailed embodiment of Model Engine 14 for receiving user input 12 received via table driven interface such as web page 25 of FIG. 2. FIG. 2 illustrates a sample table driven model logic screen 25 comprising an HTML form. Modeling rules comprise logical statements representing traditional logic statements incorporating logical operators such as AND, OR, etc. A logical statement according to the principles of this invention comprises two parts: a condition operator and an action operator, wherein all logical condition will be represented in “AND” operator, and “OR” are eliminated and replaced by another new rule.

As defined herein, a condition comprises one or more sub-conditions. A sub-condition is a simple logical statement such as A>B, A+B>=C+D, or A+B>n, etc. The sub-conditions are AND-ed together to form a condition.

As illustrated herein, an action comprises a pre-defined set of operations, such as the sample set of sub-actions, categorized into following sub-actions:

1. ERROR AND TERMINATE

2. ERROR AND CONTINUE

3. MESSAGE

4. SELECT

5. ASSIGN

6. GENERATE

7. REMOVE

These sub-actions are executed only if that action's associated condition is true. The number of modeling rules that can be generated accordingly is infinite and is only limited by available memory and hard disk space.

Because using the “AND” and “Action” operator, this invention also follows the object oriented design where each product is an object, it has its value of product ID, and operator “AND” and “Action” as its functionality.

As shown in FIG. 4, Model Engine 14 thus compiles in steps 30 to step 33 as shown a set of model rules comprising AND, product data from user input data, and Action operator. Then in rules generator step 34, model engine 14 translates the compiled set of model rules into a Configurator Language. Configurator Language has Lisp-like syntax, and thus, for example, a statement is typically converted into the form of:

(actionoperator (operator statement) message remark product quantity)

or

(actionoperator (operator operand1 [operand2]) message remark product quantity)

operator can be: AND, OR, NOT, >, >=, =, <, <=, +, −, *, /.

actionoperator can be FATAL_ERROR, NONFATAL_ERROR, MESSAGE, SELECT, ASSIGN, GENERATE, REMOVE.

For example, the rule

if A+B>10 then error(“A+B cannot be greater than 10”), remark(“if A+B>10 then error”)

will be translated into the following:

(FATAL_ERROR (>(+A B) 10) “A+B cannot be greater than 10” “if A+B>10 then error” “0”)

Model rules comprising logic statements comprising AND, product data, and Action operator are used at runtime, while internal Configurator language statements such as illustrated above is used only for storage, but not interoperation. Therefore, there is no need for a LISP language compiler.

### Validation Engine

Validation engine process 22 is invoked by the end-shoppers, such as in step 35 during a user validation selection input. Validation offers end-shopper the option of requesting live assistance at any time during the buying process. There are two processes to achieve validation.

1. Validation Commands

Once user input is detected in step 35 for validation process, Validation Functions 41 are triggered to thereby generate Validation Commands 42, which correspondingly then trigger rules retrieval step 43 to retrieve a previously stored set of model rules from memory storage 16. Once retrieved, validate step 45 then validate retrieved data and in step 44, a refresh screen and associated retrieved data for screen refresh are then executed to refresh the user screen display with validated data.

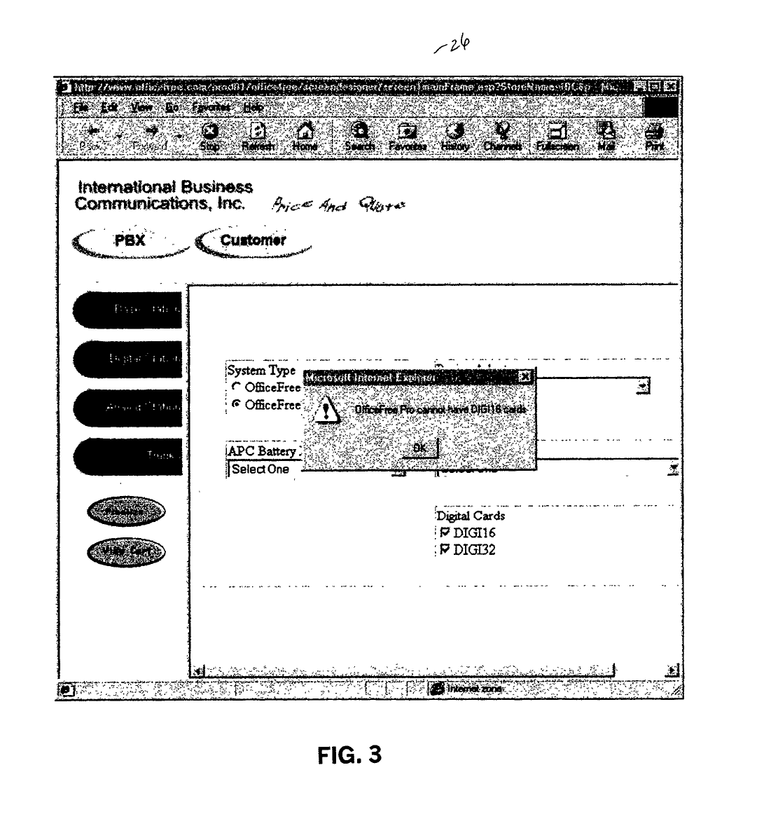

A Validation process 22 can be triggered via an Internet browser through user inputs, such as click, Change, focus etc., Validation commands 22 collects user inputs and call Configuration commands to validate all the user selections based on the Model rules. Model rules then creates a new set of validated components in the database for the Validation commands to retrieve. After a series of checking and repainting the screens, Validation Engine 22 then generates the right screen output to display messages, such as the screen page shown in FIG. 3. End shoppers are thus notified whether the desired selection is valid or not.

### Configuration Engine

Configurator Engine 18 performs three main functions:

1. Retrieves modeling rules in Configurator commands.

2. Translates modeling rules into OfficeFree Configurator commands.

3. Executes the Configurator commands.

### Rules Retrieval

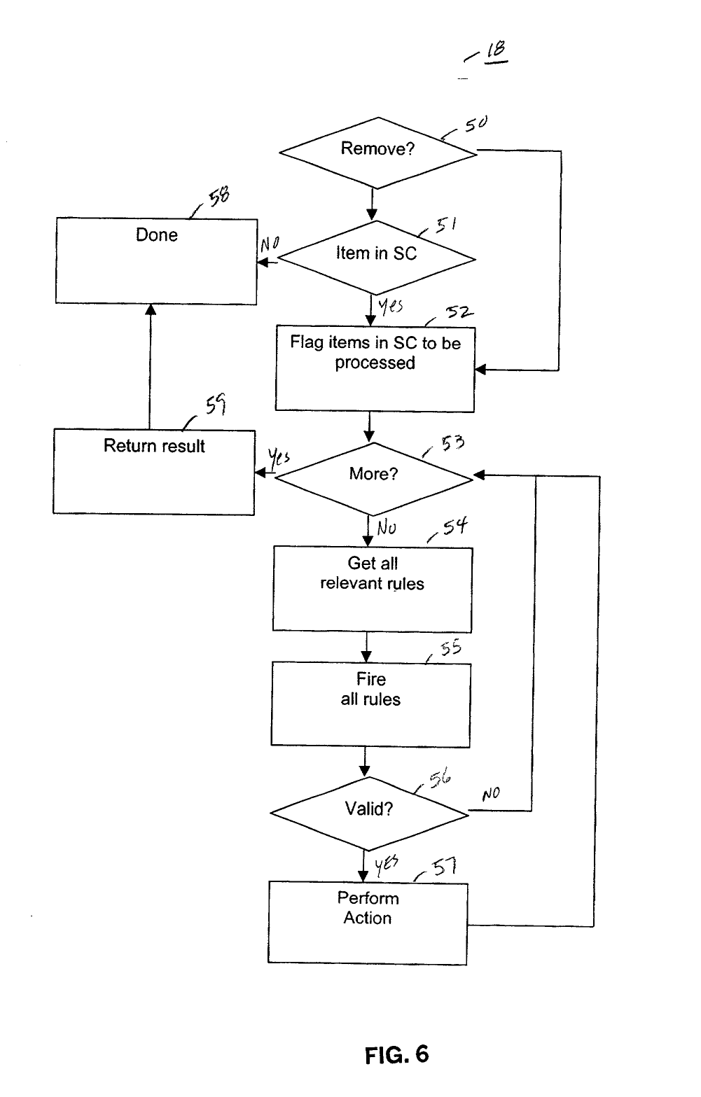

Configurator Engine 18 retrieves all modeling rules pertaining to a given product as indicated by Screen Validation process 18 shown in FIG. 6. Configuration Engine 18 determines which rules are relevant to a given product by analyzing the rules database stored during model engine process 14. A product is defined as relevant to another if it appears on the same modeling rule as the other. For example, in the following rule:

if A+B>C then error(“ . . . ”) remark(“ . . . ”) . . .

A, B, and C are relevant.

For optimization purposes, rules that have already been executed will not be retrieved again.

2. Rules Translation

The modeling rules are in proprietary Configurator commands. The Configurator will translate them into Configurator Commands, a form that is executable by the Engine. Configurator Commands have syntax similar to that of OfficeFree proprietary statements. For example, the rule:

if A>1 then . . .

will be translated in something like

SELECT: 1

FROM: ShoppingCart

WHERE: ProductCode=A AND A.Qty>1

. . .

### Rules Execution

After the rules are translated into Configurator Commands, such as shown above, Configuration Engine 18 then in step 55 execute the model rules one by one. The commands stop at the first model rule that returns a logical result of false. In that case, Configuration Engine 18 then returns the process steps back to step 54 to detect whether more items need be processed, if not, then the Screen Validation Commands with a status of false is then return as a result in step 59. Otherwise, if all the rules yield true, Configuration Engine 18 performs the action as specified in the rules in step 57. It will also return to the Screen Validation Engine with a status of true and, if necessary, some message to be displayed in step 59. To optimize the execution time, Configuration Engine 18 maintains an internal cache that keeps track of the results for each executed rule.

### Conclusion

Because of the simplification of using only an “AND” operator and an “Action”, operator, table driven Configurator 10 in accordance with the principles of this invention realizes a table driven configurator methodology. With table driven methodology, Configurator engine 10 can then be 100% web-centric. The value of a 100% web-centric methodology is to move the maintenance of Configurator 10 to the Internet so that end-users will receive the latest price quotation without any software updates and installation.

Without using the traditional language driven Configurator, there is no language compiler involved, and no compilation needed. Therefor, a Quotation can happen on the Internet for products with complex product rules.

### REFERENCE EXAMPLES

### Example 1

For example, buying PC (Product ID “S001”) will automatically purchase two 2 pieces of Interface cards (Product ID “I001”).

Using a LISP language will need to write syntax as follows then follows the compilation, before it can be used:

(A has “Value”, “Qty”, . . . )

(B has “Value”, “Qty”, . . . )

(Declare A a)

(Declare B b)

if (=(a.value, “S001”)) then (=(b.value, “I001”) AND=(b.QTY, 2))

In addition, each new rule will take above language rewritten and re-complied.

However, above language can be simplified by entering “Model design screen”:

1. Enter “1” in the first line of quantity, select “S001” from the drop down products list.

2. Select “=” in the operator list

3. Enter “1” in the 2^{nd} line of quantity under first “AND” operation.

4. Select “Assign” in the Action drop down list box.

5. Select “I001” in the drop down list below, and enter a quantity of 2

6. Enter a description of the rule in the “Description” box.

7. Click “Submit”

### Example 2

For example, buying a PC (Product ID “S001”) cannot purchase another Interface card (Product ID “I002”).

Using a LISP language will need to write a syntax as follows, then follows the compilation, before it can be used:

(A has “Value”, “Qty”, . . . )

(B has “Value”, “Qty”, . . . )

(Declare A a)

(Declare B b)

if ((=(a.value, “S001) AND=(b.value, “I002”) AND=(b.QTY, 1)) then (execute message.exe)

When the message.exe is another program written in other high level language such as C++ or Basic to generate an error message.

However, using your Model designer screen, this lengthy programming process can be simplified by clicking in the input:

1. Enter “1” in the first line of quantity, select “S001” from the drop down products list.

2. Select “=” in the operator list

3. Enter “1” in the 2^{nd} line of quantity under first “AND” operation, select “I002” in the drop down product list in the 2^{nd} section.

4. Select “Error and terminate” in the Action drop down list box.

5. Enter the error message you would like to be displayed in the “Message” box.

6. Enter a description of the rule in the “Description” box.

7. Click “Submit”

Without compilation and deployment, the end-use will get the error message prompted to their eyes when “I002” interface card is selected.

### Example 3

Buying a PC with a motherboard has limitation that mix type of memory cards will not be allowed. For example, if a marchant carries memory of EDO with 256-32 MB RAM and SDRAM with 256-32 MB, but with the motherboard's limitation, a shopper will not allow to have mix type of EDO and SDRAM of memory on the same motherboard.

Using a LISP language will need to write a syntax as follows, then follows the compilation, before it can be used:

{defun Error()}

{declare EDO256}

{declare EDO128}

{declare EDO64}

{declare EDO32}

{declare SDRM256}

{declare SDRM128}

{declare SDRM64}

{declare SDRM32}

{defun memorycheck()

{if {>{+{EDO256 SDDRM 256} 1} error()}}}}

{if {>{+{EDO128 SDDRM 256 } 1} error()}}}}

{if {>{+{EDO64 SDDRM 256} 1} error()}}}}

{if {>{+{EDO32 SDDRM 256} 1} error()}}}}

{if {>{+{EDO256 SDDRM 32} 1} error()}}}}

{if {>{+{EDO256 SDDRM 64} 1} error()}}}}

{if {>{+{EDO256 SDDRM 128} 1} error()}}}}

Also, you will notice that those memory types, such as EDO256, SDRM128 are predefined, in other words, they are hard-coded variable names. Thus also means that variable names needs to be added or deleted when there are changes, LISP programs also needs to be changed when new products comes in.

However, using your Model designer screen, this lengthy programming process can be simplified by clicking in the input:

1. Enter “1” in the first line of quantity, select“EDO32” from the drop down products list.

2. Select “+” from the operators list. Repeat step 1 and 2 until all the products are selected.

3. Select “>” in the relations list

4. Enter “0” in the second line of quantity.

5. In the second “AND” sub-clause, enter “1” in the first line of quantity, select “SDRAM32” from the drop down products list. Repeat step 5 and 6 until all the products are selected.

6. Select “>” in the relations list

7. Enter “0” in the second line of quantity.

8. Select “Error and terminate” in the Action drop down list box.

9. Enter the error message you would like to be displayed in the “Message” box.

10. Enter a description of the rule in the “Description” box.

11. Click “Submit”

Without compilation and deployment, the end-use will get the error message prompted to their eyes when mixed types of RAMs are selected.

Thus, a table driven configurator provided in accordance with the principles of this invention provides a flexible and easy creation of a custom user interface, that can be customized to the needs of a particular enterprise by allowing inclusion of graphics, operational features such as radio buttons and check boxes, data entry fields, selectable choices on menus, etc., without requiring a developer or user to write program code.

Foregoing described embodiments of the invention are provided as illustrations and descriptions. They are not intended to limit the invention to precise form described. In particular, Applicant contemplates that functional implementation of invention described herein may be implemented equivalently in hardware, software, firmware, and/or other available functional components or building blocks. Other variations and embodiments are possible in light of above teachings, and it is thus intended that the scope of invention not be limited by this Detailed Description, but rather by Claims following.

What claimed is:

1. A table driven configurator for generating modeling rules on a computer system the table driven configurator comprising:
a model engine for generating product rules, the model engine comprising a table driven rules generation user interface for receiving one or more user inputs and generating in response thereto a corresponding set of modeling rules;
a memory storage unit coupled to the model engine to receive and store the set of modeling rules; and
a configurator engine coupled to the memory storage unit to receive the set of modeling rules and process the set of modeling rules to thereby generate a set of screen outputs responsive to the one or more user inputs.

2. The table driven configurator of claim 1 wherein the configurator further comprises:
a validation engine for checking the received set of modeling rules and validating the set of modeling rules against a database of stored rules retrieved from the memory storage unit; and
a screen generation engine coupled to the validation engine to generate the set of screen outputs responsive to the one or more user inputs.

3. The table driven configurator of claim 1 wherein the model engine provides user remotely accessibility to the table driven rules generation interface.

4. The table driven configurator of claim 1 wherein the generated set of modeling rules comprises one or more logical statements

5. The table driven configurator of claim 4 wherein each of the generated one or more logical statements comprises a condition operator and an action operator.

6. The table driven configurator of claim 5 wherein the condition operator comprises an AND operator.

7. The table driven configurator of claim 5 wherein the condition operator consists of an AND operator.

8. The table driven configurator of claim 5 wherein the action operator comprises one of the following operations:
an error messages generation and terminate operation;
an error message generation and continue operation;
a message generation operation;
a select operation;
an assignment operation;
a generate operation; and
a remove operation.

9. A table-driven configurator method for generating modeling rules on a computer system comprising:
providing a table driven model engine for soliciting one or more user inputs and generating in response thereto a corresponding set of modeling rules;
storing the set of corresponding modeling rules in a memory storage unit; and
executing a configuration engine for retrieving the set of modeling rules from the memory storage unit and processing the set of modeling rules to thereby generate a set of screen outputs for the user responsive to the one or more user inputs.

10. The table driven configurator method of claim 9 wherein the step of providing a table driven model engine further comprises providing remote user accessibility.

11. The table driven configurator method of claim 10 wherein the step of providing remote user accessibility comprises providing remote accessibility to the table driven model engine via a computer network.

12. The table driven configurator method of claim 11 wherein the step of providing remote accessibility via the computer network further comprises using the internet.

13. The table driven configurator method of claim 9 wherein the step of executing a configuration engine comprises:
retrieving from the memory storage unit the set of modeling rules;
translating the set of modeling rules into a corresponding set of configurator commands; and
executing the set of configurator commands to thereby generate the set of screen outputs.

14. The table driven configurator method of claim 13 wherein the step of translating the set of modeling rules further comprises validating the set of configurator commands.

15. A table driven interface method for generating a set of modeling rules on a computer system comprising:
soliciting a set of user input data via a table driven user interface;
converting the solicited set of user input data into a set of modeling rules; and
storing the set of modeling rules into a memory storage unit.

16. The table driven interface method of claim 15 wherein the step of soliciting a set of user input data comprises providing to a remote user location a table driven user interface screen for receiving the set of user input data.

17. The table driven interface method of claim 15 wherein the step of converting the solicited set of user input data into a set of modeling rules comprises generating a set of logical statements in response to the solicited set of user input data.

18. The table driven interface method of claim 17 wherein the step of generating a set of logical statements comprises generating a set of logical statements, wherein each logical statement comprises a condition operator and an action operator.

19. The table driven interface method of claim 18 wherein the condition operator comprises an AND operator.

20. The table driven interface method of claim 19 wherein the action operator comprises generating a screen displayable message to an user.
